(19) United States
(12) Patent Application Publication
(10) Pub. No.: US 2017/0154066 A1
(43) Pub. Date: Jun. 1, 2017

(54) SUBSCRIPTION SERVICE FOR MONITORING CHANGES IN REMOTE CONTENT

(71) Applicant: International Business Machines Corporation, Armonk, NY (US)

(72) Inventors: Hai Ji, Beijing (CN); Xu Hua Li, Beijing (CN); Yongliang Li, Beijing (CN); Yuan Yuan Li, Beijing (CN); Randal J. Richardt, River Falls, WI (US); Hailin Wang, Beijing (CN)

(21) Appl. No.: 14/953,833

(22) Filed: Nov. 30, 2015

(51) Int. Cl. G06F 17/30

(52) U.S. Cl. CPC G06F 17/30368; G06F 17/30575

(57) ABSTRACT

An approach to enable subscription to a remote content repository without a native subscription service based on a change monitor deployed near the remote content repository. The change monitor takes advantage of a change log associated with the content repository to determine when changes to the repository occur and compares the changes from the change log to a subscription list provided from a subscription datastore. When changes in the repository match the subscription list then the change monitor sends a change notice toward the subscriber. The change monitor manages the subscription list based on polling the subscription datastore and replies to change notices indicating notices for subscribed objects are no longer necessary.

### BACKGROUND OF THE INVENTION

The present invention relates generally to the field of content management, and more specifically to managing remote content with a subscribe/notify based service for content changes.

The advancement of computer technology has led to individuals having many different computing devices. For example, a person can have a work computer, a home computer and one or more mobile devices such as smart phones and tablets. Coinciding with the growth in computing devices is a growth in the amount of data accessed by the computing devices and servers in a cloud environment for storing the data.

As these individuals move from home to work and back to home in their daily travels, they access their data from the many computing devices at their disposal. Synchronizing the access and storage of their data has become complex based on the lack of knowledge of when the data changes and which device has the most recent version of the data.

### SUMMARY

According to an embodiment of the present invention, a method for providing notification of a change in a stored object, the method comprising: loading, by a change monitor, a subscription list associated with one or more stored objects monitored by the change monitor; detecting, by the change monitor, a change in at least one of the one or more stored objects; and responsive to, detecting the change, sending, by the change monitor, a change notification identifying changed objects toward a subscriber associated with the subscription list.

According to another embodiment of the present invention, a method for stored object change notification, the method comprising: loading, by a change monitor, a first subscription list associated with one or more objects stored in a remote content repository; retrieving, by the change monitor, one or more change logs comprising one or more changes, associated with the remote content repository; retrieving, by the change monitor, a second subscription list associated with the one or more objects stored in the remote content repository; updating, by the change monitor, the first subscription list based on a difference of object identities associated with the first subscription list and object identities associated with the second subscription list; determining, by the change monitor, if at least one of the one or more changes associated with the one or more change logs are for objects identified in the first subscription list; responsive to, determining at least one of the one or more changes are for objects identified in the first subscription list, sending, by the change monitor, one or more change notifications identifying one or more changed objects toward the subscriber; receiving, by the change monitor, one or more replies to the one or more change notifications, respectively, wherein the one or more replies comprise a status code; and updating, by the change monitor, the first subscription list based on the status code.

According to another embodiment of the present invention, a method for providing notification of a change in a stored object, the method comprising: loading, by a change monitor, a subscription list associated with one or more stored objects monitored by the change monitor; detecting, by the change monitor, a change in at least one of the one or more stored objects; responsive to, detecting the change, sending, by the change monitor, a change notification identifying changed objects toward a subscriber associated with the subscription list; and updating, by the change monitor, the subscription list based on at least one of a comparison of one or more object identities and one or more status codes from one or more replies, respectively, to the change notification, and storing an updated subscription list in a local cache.

According to another embodiment of the present invention, a computer program product for stored object change notification, the computer program product comprising: one or more computer readable storage media and program instructions stored on the one or more computer readable storage media, the program instructions comprising: program instructions executed by a change monitor to, load a first subscription list associated with one or more objects stored in a remote content repository; program instructions executed by the change monitor to, retrieve one or more change logs comprising one or more changes, associated with the remote content repository; program instructions executed by the change monitor to, retrieve a second subscription list associated with the one or more objects stored in the remote content repository; program instructions executed by the change monitor to, update the first subscription list based on a difference of object identities associated with the first subscription list and object identities associated with the second subscription list; program instructions executed by the change monitor to, determine if at least one of the one or more changes associated with the one or more change logs are for objects identified in the first subscription list; responsive to, determining at least one of the one or more changes are for objects identified in the first subscription list, program instructions executed by the change monitor to, send one or more change notifications identifying one or more changed objects toward the subscriber; program instructions executed by the change monitor to, receive one or more replies to the one or more change notifications, respectively, wherein the one or more replies comprise a status code; and program instructions executed by the change monitor to, update the first subscription list based on the status code.

According to another embodiment of the present invention, a computer system for stored object change notification, the computer system comprising: one or more computer processors; one or more non-transitory computer readable storage media; program instructions stored on the one or more non-transitory computer readable storage media for execution by at least one of the one or more computer processors, the program instructions comprising: program instructions executed by a change monitor to, load a first subscription list associated with one or more objects stored in a remote content repository; program instructions executed by the change monitor to, retrieve one or more change logs comprising one or more changes, associated with the remote content repository; program instructions executed by the change monitor to, retrieve a second subscription list associated with the one or more objects stored in the remote content repository; program instructions executed by the change monitor to, update the first subscription list based on a difference of object identities associated with the first subscription list and object identities associated with the second subscription list; program instructions executed by the change monitor to, determine if at least one of the one or more changes associated with the one or more change logs are for objects identified in the first subscription list; responsive to, determining at least one of the one or more changes are for objects identified in the first subscription list, program instructions executed by the change monitor to, send one or more change notifications identifying one or more changed objects toward the subscriber; program instructions executed by the change monitor to, receive one or more replies to the one or more change notifications, respectively, wherein the one or more replies comprise a status code; and program instructions executed by the change monitor to, update the first subscription list based on the status code.

### BRIEF DESCRIPTION OF THE DRAWINGS

FIG. 1 is a block diagram of a computing environment for remote content change monitoring, in accordance with embodiments of the present invention;

FIG. 2 is a block diagram of a subscription service associated with a remote content change monitoring system, in accordance with an embodiment of the present invention;

FIG. 3A-C are flowcharts depicting operational steps of a subscription/notification methods associated with a remote content change monitoring system, in accordance with an embodiment of the present invention; and

FIG. 4 is a block diagram of internal and external components of a computing environment, in accordance with embodiments of the present invention.

### DETAILED DESCRIPTION

The embodiments depicted herein recognize the challenges of maintaining content consistency when a user moves between many different computing devices and provides updates to the content from the different computing devices. Embodiments of the present invention are approaches to providing a change monitor to enable a subscription service for receiving notices of content change in a remote repository whether or not the remote repository has a native subscribe/notify mechanism. In this fashion, multiple computing devices can maintain access to a local copy of the remote content with the assurance that the local copy incorporates prior changes made from any of the associated computing devices by the user.

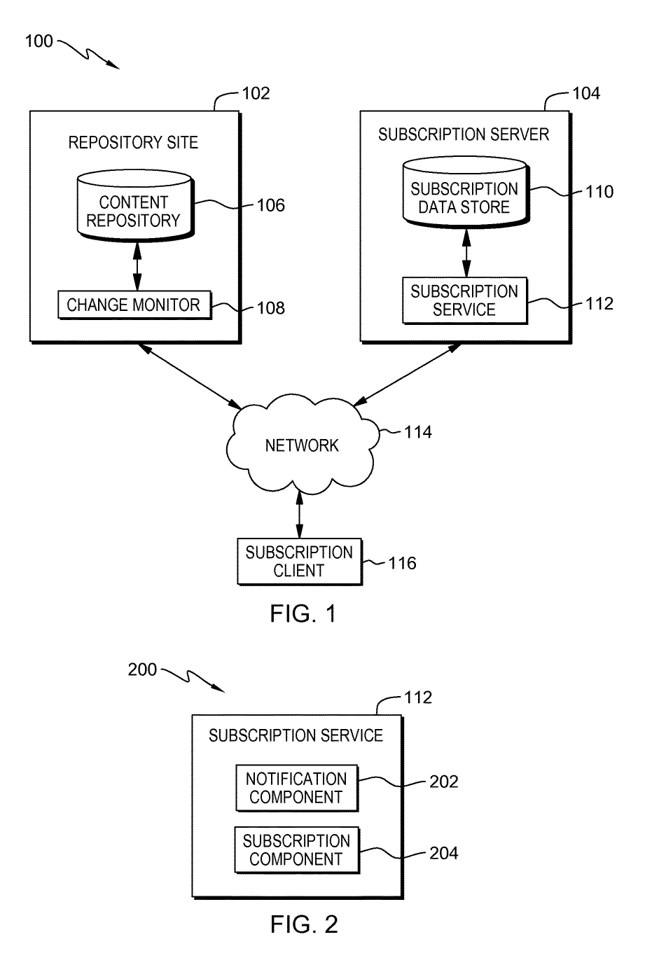

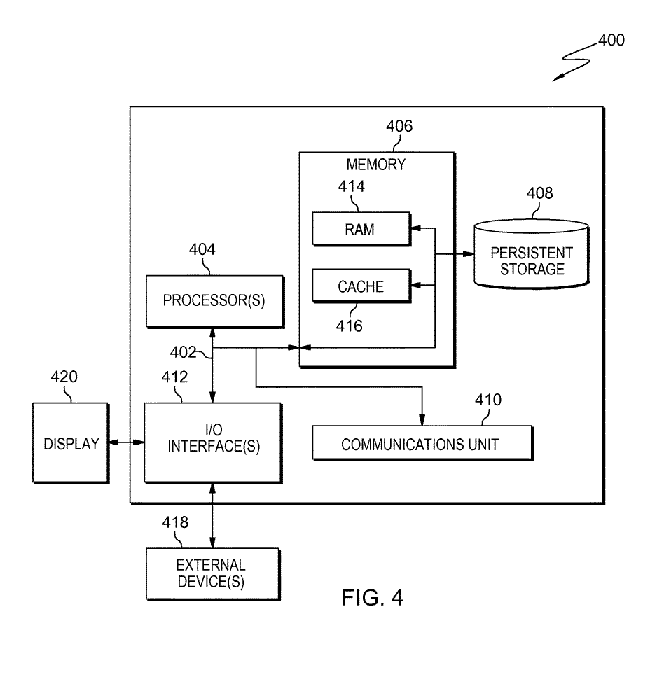

FIG. 1 depicts a block diagram of a computing environment 100, in accordance with an embodiment of the present invention. Computing environment 100 comprises a repository site 102 and a subscription server 104 wherein servers (not shown) associated with the repository site 102 and the subscription server 104 communicatively connected with subscription clients 116 via network 114. For example, such embodiments can be used in data center, cloud computing, storage area network (SAN), and network attached storage (NAS) applications. In certain embodiments, consumer computer system 102 and provider computer system 110 represent virtual machines. In general, repository site 102 and subscription server 104 are representative of any electronic devices, or combination of electronic devices, capable of executing machine-readable program instructions, as described in greater detail with regard to FIG. 4.

Subscription server 104 comprises a subscription datastore 110 and a subscription service 112. The subscription datastore 110 stores the identity of content, e.g., a list of identities of objects that users have subscribed to that reside in content repository 102. An object identity is unique in the content repository 106 and with this object identity, the embodiment can identify the associated object in the content repository 106. In another aspect, for each subscription, the embodiment assigns a subscription identifier to the subscription wherein the subscription identifier is unique in the subscription datastore 110.

The subscription identifier is an ascending sequence that increases with each new subscription. It should be noted that the subscription identifier for canceled subscriptions is not reused. A database management system (DBMS) can generate the subscription identifier, for example, a column can be defined such as, but not limited to, “GENERATED ALWAYS AS IDENTITY (START WITH 1, INCREMENT BY 1, NO CACHE). This leads to a new subscription having the largest subscription identifier in the subscription datastore 110. Accordingly, a subscriber can subscribe to multiple objects and multiple subscribers can subscribe to a single object so a mapping of subscribed users to subscribed objects is also stored in the subscription datastore 110. The mapping provides the capability to identify a list of subscribers to notify when an object is changed.

Subscription service 112 provides the capability to interact with the subscription datastore 110 and the one or more subscription clients 116. In one aspect, the subscription service 112 manages subscribers creating and deleting subscriptions for objects associated with the content repository 106. In another aspect, the subscription service 112 manages providing notice to the subscribers of changes to and the identity of objects to which they have subscribed.

Repository site 102 comprises a content repository 106 and a change monitor 108. The content repository 106 and the change monitor 108 can be on the same server or the change monitor 108 can be on a server local to the content repository 106, preferably a server with a low latency to the server hosting the content repository.

Content repository 106 is a storage location for objects such as, but not limited to, data, databases, input/output caches, documents, folders and media. It should be noted that the content repository can have a change event log for tracking any changes to the content managed by the content repository 106. It should further be noted that the content repository can have a native service for subscription change but the native service is implemented as part of the content repository and is not portable to other repositories. For example, Content Management Interoperability Services (CMIS) is an open standard allowing different content management systems to provide a common interface, e.g., a function “GetContentChanges” which can retrieve all the changes made to the repository.

Change monitor 108 is deployed in the remote site for optimizing change detection between the content repository 106 and the change monitor 108. Change monitor 108 initializes by loading and caching the subscription information obtained from the subscription datastore 110. In one embodiment, change monitor 108 can persist the cache to local storage to optimize change monitor 108 reloads from the local cache. It should be noted that the presence of an updated subscription list in the local cache can be an indicator to the change monitor 108 to load the updated subscription list from the local cache. Change monitor 108 interacts with the content repository 106 and monitors the content repository 106 for changes to the content. The change monitor 108 monitors the content repository by periodically checking the change logs associated with the content repository for changes to objects defined in the cached subscription information.

Change monitor 108 sends a notification message to subscription service 112 when change monitor 108 detects a change to an object currently under subscription by any of the subscribers associated with subscription service 112. Further, change monitor 108 tracks changes in the subscription datastore 110 for new object subscriptions or object subscription cancellations and adjusts notifications accordingly.

For an example of detecting new object subscriptions, on a predefined time interval change monitor 108 will interrogate the subscription datastore for a list of any changes in subscribed data since the last check by the calling change monitor 108. Change monitor 108 takes advantage of the mechanism (previously described) used to assign subscription identifiers, i.e., an ascending sequence without reusing unsubscribed identifiers, to quickly determine if the cache requires updating based on new subscriptions. For example, the change monitor 108 notes that the highest subscription identifier it possesses is 1959 when it interrogates the subscription datastore 110. The result of the interrogation shows that the current highest subscription identifier in the subscription datastore 110 is 1977, numerically greater, wherein the change monitor 108 updates the cache with the latest subscription data.

Considering an example of an alternative embodiment for detecting new subscriptions, the change monitor 108 can send the highest, i.e., maximum, subscription identifier it possesses, e.g., 1959, towards the subscription service 112. The subscription service 112 can provide the change monitor a list of subscriptions with subscription identifiers numerically greater than 1959 and up to the highest subscription identifier in the subscription datastore 110, e.g., from 1960 to 1977, wherein 1977 is the highest subscription identifier, i.e., of a numerically greatest value, at the time of the request. When the change monitor receives the list it can simply update the cache with the provided list based on the fact that the subscription service 112 assigns subscription identifiers in an ascending order.

For an example of detecting canceled subscriptions, change monitor 108 sends a change notice toward notification component 202. Notification component 202, while processing the change notice, determines from interrogation of subscription datastore 110 that the associated subscription client 116 has canceled the subscription. Accordingly, notification component 202 sends a message to change monitor 108 to remove the subscription and stop providing notices toward the associated subscription client 116 for the subscription object.

Network 114 can be, for example, a telecommunications network, a local area network (LAN), a wide area network (WAN), such as the Internet, or a combination of these, and can include wired, wireless, or fiber optic connections. Network 114 can include one or more wired and/or wireless networks that are capable of receiving and transmitting data, voice, and/or video signals, including multimedia signals that include voice, data, and video information. In general, network 114 can be any combination of connections and protocols that will support communications between repository server 102, subscription server 104 and one or more subscription clients 116 within computing environment 100.

Subscription client 116 can be any programmable electronic device capable of executing machine-readable instructions and communicating with various components and devices, such as, but not limited to, repository server 102 and subscription server 104, within computing environment 100. For example, subscription client 116 can be a desktop computer, a laptop computer, a mobile device, or any other suitably configured device.

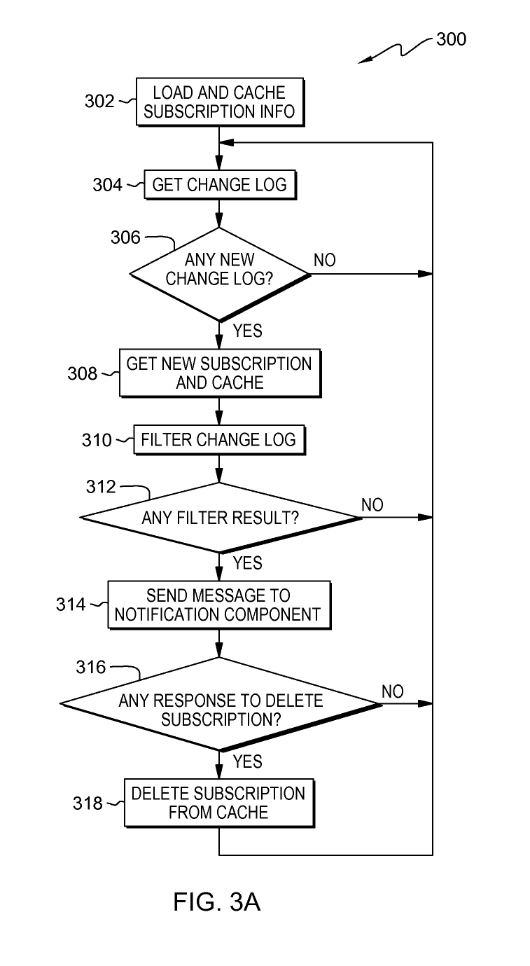

FIG. 2 depicts a block diagram of a component 200 of subscription server 104, i.e., subscription service 112, in accordance with an embodiment of the present invention. Subscription service 112 comprises a notification component 202 and a subscription component 204.

Notification component 202 provides the capability to send notifications of changes to subscribed objects to one or more subscription clients 116, e.g., users' mobile devices. The notification comprises the identity of the object that changed. Based on the information in the notification, the user can take appropriate action such as, but not limited to, locating and retrieving a new copy of the object from the content repository 106. It should be noted that more than one user can be subscribed to the same object and accordingly, a notification will be sent to each subscribed user.

Subscription component 204 provides the capability to receive and process subscribe/unsubscribe requests from a subscription client 116. After a subscription client 116 has sent a subscribe/unsubscribe request to subscription component 204, subscription component 204 updates the subscription datastore 110 with information describing the request. For example, a subscription request comprises the location and identity of an object from which the subscription client 116 desires to see change notifications. The type of change the request comprises at least one of updating, deleting, reindexing, etc. It should be noted that objects such as, but not limited to, folders can further comprise notifications associated with adding objects to the folder and deleting objects from the folder.

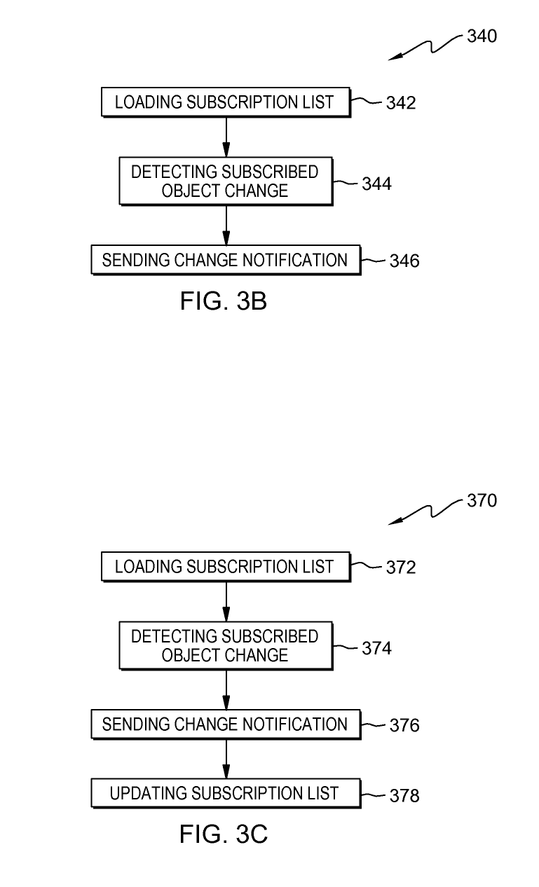

FIG. 3A depicts an embodiment of operational steps of a subscription content change method 300 performed by change monitor 108, in accordance with an embodiment of the present invention.

In step 302, change monitor 108 loads the object subscription list from the subscription datastore 110. The change monitor 108 caches the object subscription list locally. In an alternative embodiment, the change monitor 108 persists the cache locally so a reload of the cache does not require communication with the subscription datastore 110. Next, in step 304, the change monitor 108 obtains the current change log from the content repository 106. It should be noted that the current change log comprises all changes to the content repository, not just the changes associated with the object subscription list.

Next, in step 306, the change monitor 108 determines if there are any new changes in the change log. It should be noted that new changes are changes having occurred since the previous change was detected. If the change monitor 108 does not detect any new changes, then the change monitor 108 returns to step 304 to look for new changes. It should be noted that a time delay can be configured before the next check for changes. The configured time delay can be predetermined or, in an alternative embodiment, the time delay can be automatically configured based on factors such as, but not limited to, the amount of time since the last change was detected.

In step 308, when new changes from the content repository are available, the change monitor 108 obtains a fresh copy of the object subscription list from the subscription datastore 110 and caches the object subscription list. In processing the fresh copy, the change monitor 108 determines if any of the subscription identifiers in the fresh copy are greater that the subscription identifiers in the cache, i.e., determines if there are any new subscriptions. If there are new subscriptions then the change monitor 108 adds the new subscriptions to the cache.

Next, in step 310, the change monitor 108 determines if any of the new changes in the change log correspond to objects associated with the subscription identifiers in the cache. Then, at step 312, if the change monitor 108 does not detect any matches between the new changes and the objects associated with the subscription identifiers in the cache, then the change monitor 108 returns to step 304 to look for changes. If the change monitor 108 detects matches, then the change monitor 108 proceeds to step 314.

In step 314, the change monitor 108 sends a notification, toward the notification component 202, indicating that there are changes to subscribed objects. The change monitor 108 then receives a response to the previously sent notification indicating the status of the message delivery. Next, at step 316, the change monitor determines if the received response includes an unsubscribe status code indicating that an object is no longer subscribed to by any subscription client 116. If the unsubscribe status code is not received then the change monitor 108 returns to step 304 to look for changes. If the unsubscribe code is received then the change monitor proceeds to step 318. In step 318, the change monitor 108 removes the associated subscription identifier from the cache and returns to step 304 to look for changes.

FIG. 3B depicts an alternative embodiment of operational steps of a subscription content change method 340 performed by change monitor 108, in accordance with an embodiment of the present invention. At step 342, change monitor 108 loads the subscription as previously described. Next at step 344, the change monitor 108 detects a change in a subscribed object as previously described. Next at step 346, change monitor 108 sends a change notification toward the subscriber as previously described.

FIG. 3C depicts another alternative embodiment of operational steps of a subscription content change method 370 performed by change monitor 108, in accordance with an embodiment of the present invention. At step 372, change monitor 108 loads the subscription as previously described. Next at step 374, the change monitor 108 detects a change in a subscribed object as previously described. Next at step 376, change monitor 108 sends a change notification toward the subscriber as previously described. Next at step 378, change monitor 108 updates the subscription list as previously described.

FIG. 4 depicts a block diagram 400 of components of computing device 104 in accordance with an illustrative embodiment of the present invention. It should be appreciated that FIG. 4 provides only an illustration of one implementation and does not imply any limitations with regard to the environments in which different embodiments may be implemented. Many modifications to the depicted environment can be made.

Computing device 104 includes communications fabric 402, which provides communications between computer processor(s) 404, memory 406, persistent storage 408, communications unit 410, and input/output (I/O) interface(s) 412, and cache 414. Communications fabric 402 can be implemented with any architecture designed for passing data and/or control information between processors (such as microprocessors, communications and network processors, etc.), system memory, peripheral devices, and any other hardware components within a system. For example, communications fabric 402 can be implemented with one or more buses.

Memory 406 and persistent storage 408 are computer readable storage media. In this embodiment, memory 406 includes random access memory (RAM) and cache memory 414. In general, memory 406 can include any suitable volatile or non-volatile computer readable storage media. Cache 414 is a fast memory that enhances the performance of computer processor(s) 404 by holding recently accessed data, and data near accessed data, from memory 406.

Analyzer component 108 and data file 110 (data file 156 in computing environment 150) are stored in persistent storage 408 for execution and/or access by one or more of the respective computer processors 404 via one or more memories of memory 406. In this embodiment, persistent storage 408 includes a magnetic hard disk drive. Alternatively, or in addition to a magnetic hard disk drive, persistent storage 408 can include a solid state hard drive, a semiconductor storage device, read-only memory (ROM), erasable programmable read-only memory (EPROM), flash memory, or any other computer readable storage media that is capable of storing program instructions or digital information.

The media used by persistent storage 408 may also be removable. For example, a removable hard drive can be used for persistent storage 408. Other examples include optical and magnetic disks, thumb drives, and smart cards that are inserted into a drive for transfer onto another computer readable storage medium that is also part of persistent storage 408.

Communications unit 410, in these examples, provides for communications with other data processing systems or devices. Communications unit 410 can include one or more network interface cards. Communications unit 410 can provide communications through the use of either or both physical and wireless communications links. Analyzer component 108 can be downloaded to persistent storage 408 through communications unit 410.

I/O interface(s) 412 allows for input and output of data with other devices that can be connected to computing device 104. For example, I/O interface 412 can provide a connection to external devices 416 such as a keyboard, keypad, a touch screen, and/or some other suitable input device. External devices 416 can also include portable computer readable storage media such as, for example, thumb drives, portable optical or magnetic disks, and memory cards. Software and data used to practice embodiments of the present invention, e.g., analyzer component 108 and data 110 (data file 156 in computing environment 150), can be stored on such portable computer readable storage media and can be loaded onto persistent storage 408 via I/O interface(s) 412. I/O interface(s) 412 also connect to a display 418.

Display 418 provides a mechanism to display data to a user and may be, for example, a touchscreen.

The programs described herein are identified based upon the application for which they are implemented in a specific embodiment of the invention. However, it should be appreciated that any particular program nomenclature herein is used merely for convenience, and thus the invention should not be limited to use solely in any specific application identified and/or implied by such nomenclature.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the invention. The terminology used herein was chosen to best explain the principles of the embodiment, the practical application or technical improvement over technologies found in the marketplace, or to enable others of ordinary skill in the art to understand the embodiments disclosed herein.

1-5. (canceled)

6. A method for providing stored object change notification, the method comprising:
accessing, by a change monitor, a first subscription list associated with one or more objects stored in a remote content repository, wherein the change monitor is deployed with the remote content repository and the remote content repository does not have a native subscription service;
updating, by the change monitor, the first subscription list based on a difference of object identities associated with the first subscription list and object identities associated with a second subscription list;
identifying, by the change monitor, a changed object in the updated first subscription list based on a change log associated with the remote content repository;
sending, by the change monitor, a change notification identifying the changed object to a subscriber.

7. The method of claim 6, wherein the updating comprises adding, by the change monitor, object identities to the first subscription list, from the second subscription list.

8. The method of claim 6, further comprising:
deleting, by the change monitor, an object identity in the updated first subscription list associated with a reply to the change notification.

9. The method of claim 6, wherein the difference of object identities is based on one or more object identities associated with the second subscription list being numerically greater than the object identities associated with the first subscription list.

10. The method of claim 6, wherein the first subscription list is accessed from a local cache and the second subscription list is accessed from a subscription datastore.

11. A method for providing notification of a change in a stored object, the method comprising:
accessing, by a change monitor, a subscription list associated with one or more stored objects, wherein the change monitor is deployed with the one or more stored objects and the one or more stored objects do not have native change subscription services;
responsive to detecting a change in at least one of the one or more stored objects, by the change monitor, sending a change notification identifying changed objects to a subscriber associated with the subscription list.

12. The method of claim 11, further comprising:
responsive to detecting a subscription list in a local cache, by the change monitor, accessing the subscription list.

13. The method of claim 11, further comprising:
updating the subscription list based on adding object identities to the subscription list from a second subscription list that are numerically greater than object identities in the subscription list.

14. The method of claim 13, wherein the updating further comprises deleting one or more object identities associated with one or more replies, respectively.

15. The method of claim 11, wherein detecting the change is based on one or more change logs associated with a content repository.

16. A computer program product for providing stored object change notification, the computer program product comprising:
one or more computer readable storage media and program instructions stored on the one or more computer readable storage media, the program instructions comprising:
program instructions executed by a change monitor to load a first subscription list associated with one or more objects stored in a remote content repository wherein the change monitor is deployed with the remote content repository and the remote content repository does not have a native subscription service;
program instructions executed by the change monitor to update the first subscription list based on a difference of object identities associated with the first subscription list and object identities associated with a second subscription list;
program instructions executed by the change monitor to identify a changed object in the updated first subscription list based on a change log associated with the remote content repository;
program instructions executed by the change monitor to send a change notification identifying the changed object to a subscriber.

17. The computer program product of claim 16, wherein the program instructions executed by the change monitor to update comprises program instructions executed by the change monitor to add object identities to the first subscription list from the second subscription list.

18. The computer program product of claim 16, further comprising:
program instructions executed by the change monitor to delete an object identity in the updated first subscription list associated with a reply to the change notification.

19. The computer program product of claim 16, wherein the difference of object identities is based on one or more object identities associated with the second subscription list being numerically greater than the object identities associated with the first subscription list.

20. The computer program product of claim 16, wherein the first subscription list is accessed from a local cache and the second subscription list is accessed from a subscription datastore.

21. A computer system for providing stored object change notification, the computer system comprising:
one or more computer processors;
one or more non-transitory computer readable storage media;
program instructions stored on the one or more non-transitory computer readable storage media for execution by at least one of the one or more computer processors, the program instructions comprising:
program instructions executed by a change monitor to load a first subscription list associated with one or more objects stored in a remote content repository wherein the change monitor is deployed with the remote content repository and the remote content repository does not have a native subscription service;
program instructions executed by the change monitor to update the first subscription list based on a difference of object identities associated with the first subscription list and object identities associated with a second subscription list;
program instructions executed by the change monitor to identify a changed object in the updated first subscription list based on a change log associated with the remote content provider;
program instructions executed by the change monitor to send a change notification identifying the changed object to a subscriber.

22. The computer system of claim 21, wherein the program instructions executed by the change monitor to update comprises program instructions executed by the change monitor to add object identities to the first subscription list from the second subscription list.

23. The computer system of claim 21, further comprising:
program instructions executed by the change monitor to delete an object identity in the updated first subscription list associated with a reply to the change notification.

24. The computer system of claim 21, wherein the difference of object identities is based on one or more object identities associated with the second subscription list being numerically greater than the object identities associated with the first subscription list.

25. The computer system of claim 21, wherein the first subscription list is accessed from a local cache and the second subscription list is accessed from a subscription datastore.
